(19) United States
(12) Patent Application Publication
(10) Pub. No.: US 2019/0279444 A1
(43) Pub. Date: Sep. 12, 2019

(54) GRAPHICAL USER INTERFACE FOR EFFICIENTLY VIEWING VEHICLE TELEMATICS DATA TO IMPROVE EFFICIENCY OF FLEET OPERATIONS

(71) Applicant: ZONAR SYSTEMS, INC., Seattle, WA (US)

(72) Inventor: CHARLES MICHAEL MCQUADE, ISSAQUAH, WA (US)

(73) Assignee: ZONAR SYSTEMS, INC., SEATTLE, WA (US)

(21) Appl. No.: 16/423,486

(22) Filed: May 28, 2019

Related U.S. Application Data
(63) Continuation of application No. 14/659,406, filed on Mar. 16, 2015.
Application No. 14/659,406 is a continuation-in-part of application No. 14/275,836, filed on May 12, 2014, now abandoned.
(60) Provisional application No. 61/954,422, filed on Mar. 17, 2014.
(60) Provisional application No. 61/823,342, filed on May 14, 2013.
(60) Provisional application No. 61/822,417, filed on May 12, 2013.
(60) Provisional application No. 61/822,420, filed on May 12, 2013.

(51) Int. Cl. G07C 5/08; G07C 5/00

(52) U.S. Cl. CPC G07C 5/0825; G07C 5/008

(57) ABSTRACT

Data is collected during the operation of multiple vehicles in a fleet. Such data can be used by fleet operators for efficiency analysis and improvements; however, the sheer quantity of available data makes such analysis potentially difficult and time consuming. Disclosed herein are several fleet performance monitoring graphical user interfaces (GUI) that simultaneously display different types of fleet data to a user, using combinations of different data types designed to enable fleet users to efficiently manage their fleet by trends and exceptions, which are efficiently and graphically presented to the fleet operator. One such GUI simultaneously displays fleet vehicles on a map, alerts by vehicle, fleet uptime, and maintenance information. In at least one embodiment, the map identifies vehicles having critical alerts using a different color coding than vehicles not associated with such alerts. In at least one embodiment, the fleet uptime metrics simultaneously display vehicle metrics and driver metrics.

### RELATED APPLICATIONS

This application is a continuation of application Ser. No. 14/659,406 filed Mar. 16, 2015, which itself is a continuation-in-part of application Ser. No. 14/275,836, filed on May 12, 2014, which itself is based on the following prior co-pending provisional applications; Ser. No. 61/822,417, filed on May 12, 2013, Ser. No. 61/822,420, filed on May 12, 2013, Ser. No. 61/823,342, filed on May 14, 2013, and Ser. No. 61/954,422, filed on Mar. 17, 2014, the benefits of the filing dates of which are hereby claimed under 35 U.S.C. § 119(e) and 35 U.S.C. § 120. All of the above listed applications are incorporated by reference as if fully set forth herein.

### BACKGROUND

As the cost of sensors, communications systems and navigational systems has dropped, operators of commercial and fleet vehicles now have the ability to collect a tremendous amount of data about the vehicles that they operate, including how the vehicles are being driven by the drivers operating such vehicles.

Unfortunately, simply collecting such data does not automatically translate into cost savings. It would be desirable to provide such fleet operators with additional tools in order to derive a benefit from the wealth of data that can be collected. Preferably, such tools can be used to provide feedback to fleet operators that can be translated into cost savings.

### SUMMARY

One aspect of the concepts disclosed herein is a fleet performance monitoring graphical user interface (GUI) that simultaneously displays fleet vehicles on a map, alerts by vehicle, fleet uptime, and maintenance information. In at least one embodiment, the map identifies vehicle having critical alerts using a different color coding than vehicles not associated with such alerts. In at least one embodiment, the alerts include speeding events by driver. In at least one embodiment, the fleet uptime metrics simultaneously display vehicle metrics and driver metrics. In at least one embodiment, the fleet uptime metrics are based on a ring-shaped icon, with higher percentages being indicated by displaying a corresponding portion of the ring using a different shading pattern. In at least one embodiment, the maintenance metrics for a plurality of vehicles are simultaneously displayed.

Another aspect of the concepts disclosed herein is a fleet performance monitoring GUI that simultaneously displays information specific to a unique asset, as well as insights and corresponding to the vehicle type (i.e., operating parameters and statistics relating to that specific vehicle, such as a 1998 Volvo heavy duty commercial truck).

Yet another aspect of the concepts disclosed herein is a fleet performance monitoring GUI for pupil transportation that simultaneously displays key performance indicators (KPIs), service metrics and insights.

Still another aspect of the concepts disclosed herein is a fleet performance monitoring GUI for pupil transportation that simultaneously safety metrics specific to that operators own fleet, and for the industry as a whole on the same screen.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a high level flow chart showing the overall method steps implemented in accord with one exemplary embodiment for achieving the concepts disclosed herein;

FIG. 2 schematically illustrates a vehicle that includes a plurality of sensors configured to collect the required metrics;

FIG. 3A is a functional block diagram illustrating the functional elements of an embodiment in which the metrics are processed within the vehicle in real-time;

FIG. 3B is a functional block diagram illustrating the functional in accord with one aspect of the concepts disclosed herein elements of an embodiment in which the metrics are processed by a computing device remote from the vehicle;

FIG. 4 schematically illustrates a vehicle that includes a GPS unit configured to collect GPS data that can be used to determine a plurality of metrics for use in determining a driver performance ranking;

FIG. 5 is a functional block diagram illustrating exemplary elements in a vehicle/driver performance monitoring system in accord with one aspect of the concepts disclosed herein;

FIG. 6 is another functional block diagram illustrating exemplary elements in a vehicle/driver performance monitoring system in accord with one aspect of the concepts disclosed herein;

FIG. 7 is an exemplary computing environment for implementing some of the concepts disclosed herein;

FIG. 8 is a functional block diagram of an exemplary telematics device added to an enrolled vehicle to implement one or more of the methods disclosed herein;

FIG. 9 is a functional block diagram of an exemplary telematics oriented tablet for in vehicle use that may be employed in accord with some aspect of the concepts disclosed herein; and

FIG. 10 is an exemplary screen shot of a webpage (or GUI) accessed by a user to see summarized fleet information that can be used to quickly obtain a high level overview of the fleet, including location, alerts, uptime statistics, and in some cases maintenance statistics;

FIG. 11 is an exemplary screen shot of a webpage (or GUI) accessed by a user to see summarized vehicle information that can be used to quickly obtain a high level overview of one specific vehicle in the fleet, including current status, historical statistics for that specific vehicle, and insights related that specific make and model vehicle;

FIG. 12 is an exemplary screen shot of a webpage (or GUI) accessed by a user to see summarized fleet information that can be used to quickly obtain a high level overview of key performance indicators for the fleet, including safety metrics, trip duration metrics, industry insights, cost per trip metrics, on time performance metrics, and fleet uptime/downtime metrics; and

FIG. 13 is an exemplary screen shot of a webpage (or GUI) accessed by a user to see summarized fleet information that can be used to quickly obtain a high level overview of key performance indicators for the fleet, including vehicle defects, idle time metrics, mileage metrics, speed violation metrics, and vehicle inspection metrics.

### FIGURES AND DISCLOSED EMBODIMENTS ARE NOT LIMITING

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

### Overview of Subject Matter Presented Herein

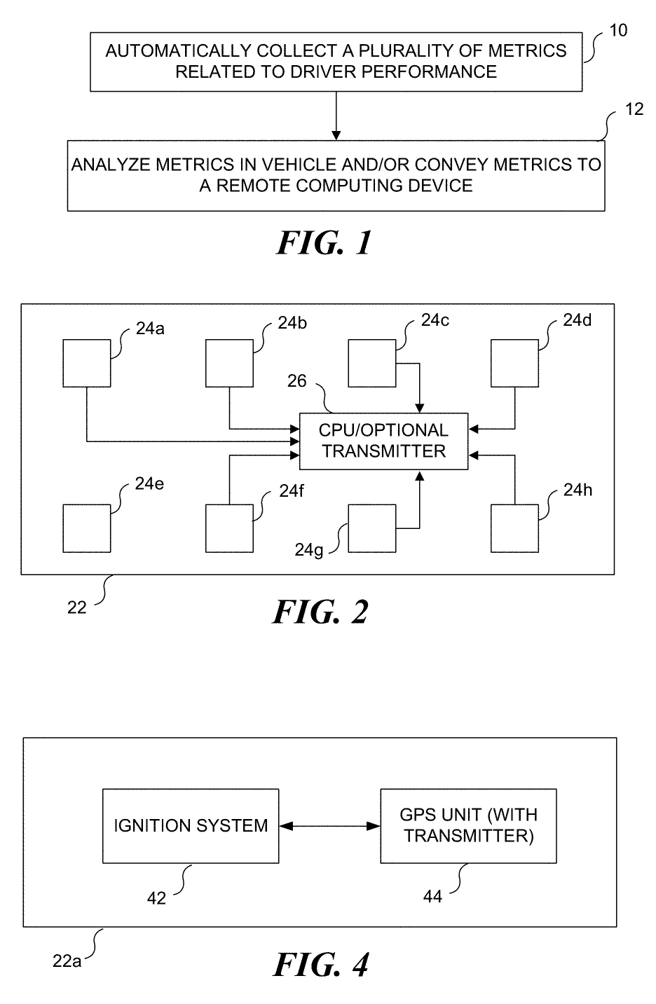

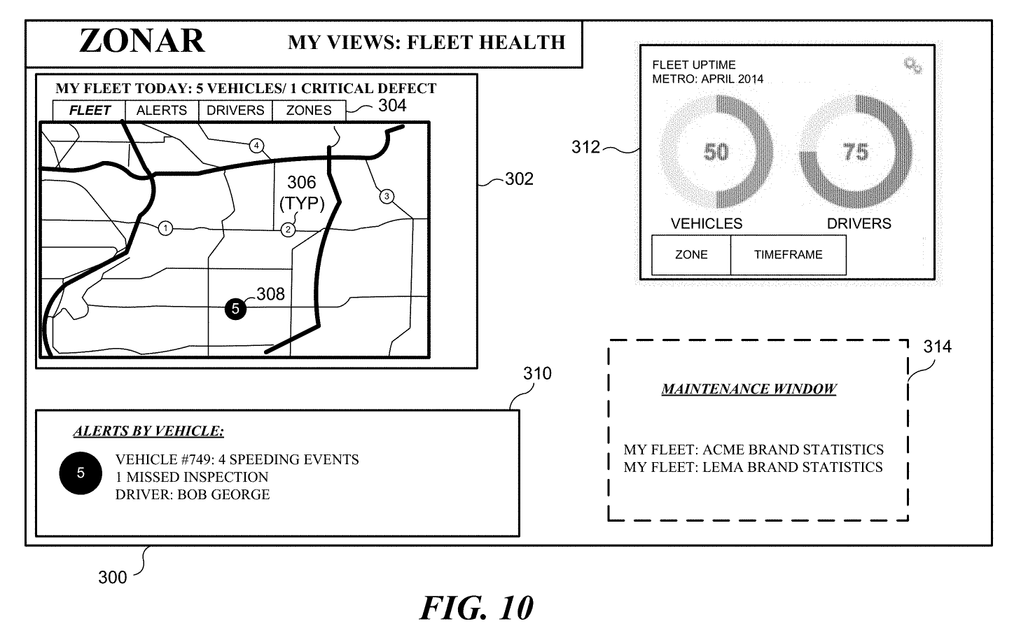

FIGS. 1-9 provide details on exemplary systems and techniques for collecting data in a fleet management system that includes hardware on fleet vehicles and remote computing devices for analyzing collected data. FIGS. 10-12 specifically disclose new GUIs for presenting such data to users in a logical, efficient and novel format. These GUIs can be presented to the user as a webpage, or as a GUI provided by a stand-alone software application.

### Non-Transitory Memory Medium

Many of the concepts disclosed herein are implemented using a processor that executes a sequence of logical steps using machine instructions stored on a physical or non-transitory memory medium. It should be understood that where the specification and claims of this document refer to a memory medium, that reference is intended to be directed to a non-transitory memory medium. Such sequences can also be implemented by physical logical electrical circuits specifically configured to implement those logical steps (such circuits encompass application specific integrated circuits).

### Exemplary Logic for Determining Driver/Vehicle Performance

FIG. 1 is a high level flow chart showing the overall method steps implemented in accord with one aspect of the concepts disclosed herein. In a block 10 a plurality of metrics related to vehicle or driver performance and/or vehicle performance are automatically collected by a plurality of sensors incorporated into a vehicle. Such metrics can include, but are not limited to, vehicle speed, vehicle acceleration, vehicle deceleration, engine RPMs, idle time, engine temperature, coolant temperature, oil temperature, fuel consumption, and vehicle positional data. Those of ordinary skill in the art will readily recognize that many different metrics related to vehicle performance and driver performance can be collected. Thus, it should be recognized that the specifically identified metrics are intended to be exemplary, rather than limiting. In a block 12, the metrics are analyzed in the vehicle, and/or conveyed to a remote computing device for analysis. Various embodiments of the concepts disclosed herein implement permutations and combinations of data analysis at the vehicle and remotely.

FIG. 2 schematically illustrates a vehicle including a plurality of sensors configured to collect the required metrics. A vehicle 22, such as a bus or a truck, includes a plurality of sensors 24a-24h. It should be recognized that the specific number of sensors, and the specific types of sensors and types of data collected by the sensors, are not critical, so long as the sensors collect data for the desired metrics. As noted above, a plurality of different metrics have been specifically identified, however it should be recognized that such metrics are intended to be exemplary, and not limiting on the concepts disclosed herein. In the disclosed exemplary embodiment, each sensor is coupled to a CPU 26 (which, as described in greater detail below, may in some of embodiments be replaced with (or provided in addition to) a transmitter).

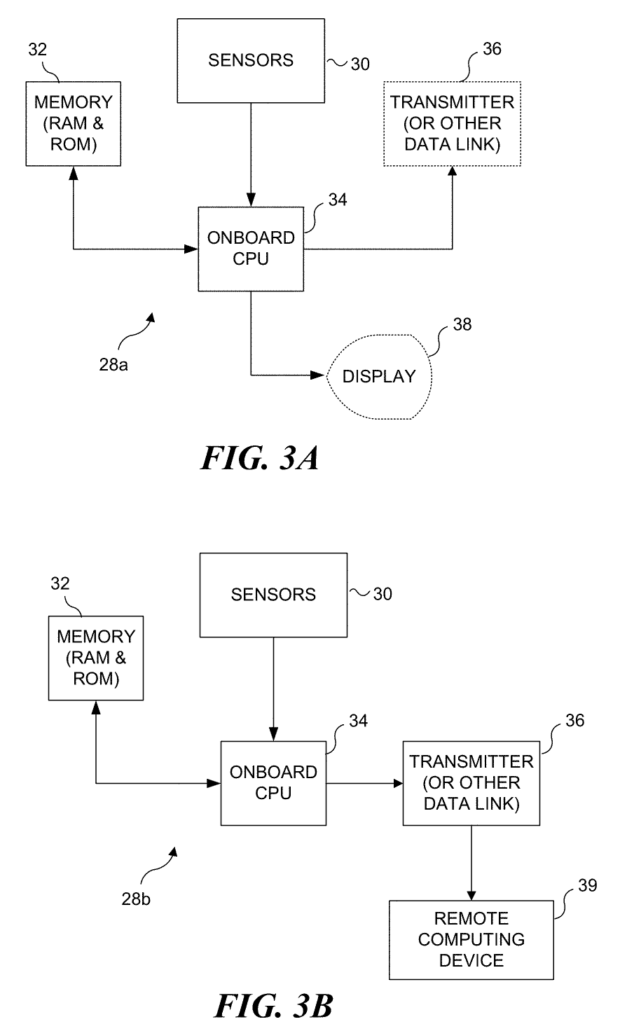

FIG. 3A is a functional block diagram 28a illustrating the functional elements of an exemplary embodiment in which the metrics are processed within the vehicle. The vehicle is equipped with sensors 30 configured to collect the required metrics. The sensors are logically coupled with an onboard vehicle CPU 34, which is configured to implement the method steps generally described above. CPU 34 is logically coupled to a memory 32 in which are stored the machine instructions that are executed by the CPU to carry out these logical steps. The plurality of metrics collected by sensors 30 can also be stored in memory 32. A (preferably optical or wireless) transmitter 36 (or other data link) can be included to enable either the plurality of metrics or the analysis to be communicated to a remote computing device. An optional display 38 can be included in the vehicle to provide real-time feedback to the driver.

FIG. 3B is a functional block diagram 28b illustrating the functional elements of an exemplary embodiment in which the metrics are processed by a remote computing device. Once again, the vehicle is equipped with sensors 30 configured to collect the required metrics. The sensors are logically coupled with an onboard vehicle CPU 34, which is configured to transmit the collected metrics to remote computing device 39 through transmitter 36 (or other data link). In a particularly preferred embodiment, transmitter 36 is a wireless transmitter. In such an embodiment, the method steps generally described above for processing the collected metrics can be executed by the remote computing device. CPU 34 is logically coupled to memory 32 in which the collected metrics can be stored, if the metrics are not to be transmitted to the remote computing device in real-time. Even if the metrics are transmitted to the remote computing device in real-time, such metrics can be stored in memory 32 as a backup in case the transmission is not successful. In such an embodiment, a display is not likely to be beneficial, unless the remote computing device is configured to transmit the analytical results back to the vehicle for display to the driver.

FIG. 4 schematically illustrates a vehicle 22a that includes a GPS unit 44 configured to collect GPS data that can be used to determine a plurality of metrics for use in determining a driver performance ranking. Such an embodiment enables the driver performance ranking discussed above to be generated without requiring individual or additional sensors to be integrated into the vehicle (although it should be recognized that such individual sensors could be used in addition to (or as an alternative source of) the data provided by the GPS unit, to provide additional metrics used in determining a driver's performance ranking, generally consistent with the method steps described above with respect to FIG. 1). Vehicle 22a, such as a bus or a truck (or automobile, or construction equipment, generally as described above) includes GPS unit 44 coupled with an ignition system 42 of the vehicle. In an exemplary embodiment, the GPS unit will be coupled with the ignition switch, such that it is assumed that when the ignition switch is on, the engine of the vehicle is actually running, and the GPS unit will be activated. As described in greater detail below, GPS data can be used for a plurality of metrics, including idle time, deceleration time and magnitude, acceleration time and magnitude, and to determine if a driver has violated a speed limit. The most basic GPS unit is able to determine a position of the vehicle at a specific time. That positional information can be used to calculate the speed of a vehicle by determining the change in position of the vehicle between two successive points in time, and to calculate the acceleration or deceleration of the vehicle by determining the change in speed of the vehicle over a time increment. More typically, GPS units automatically determine position, speed, and acceleration/deceleration internally, and these metrics would then not need to be determined by an external computing device (remote or local).

GPS unit 44 preferably includes or is connected to a wireless transmitter (not separately shown), such that the GPS data can be wirelessly transmitted to a remote computing device, preferably in real-time. The remote computing device can be programmed to manipulate the GPS data to determine a plurality of metrics. It should be recognized that as an alternative, GPS unit 44 can include an onboard memory, such that the GPS data are stored in the GPS unit, to be uploaded to a remote computing device at a later time (for example, using a wireless or hardwired data link). Significantly, GPS unit 44 enables an analysis of driver performance or vehicle performance to be determined, even if the vehicle is not equipped with separate other sensors of the metric data or an onboard computer (as are required in the embodiments of FIGS. 2, 3A, and 3B). It should be understood that the concepts disclosed herein encompasses coupling such a GPS unit to vehicle sensors and/or a vehicle data bus, such that driver/vehicle performance data collected by other vehicle sensors can be combined with GPS data and conveyed to a remote computing site. While not specifically shown in FIG. 4, it should be understood that GPS unit 44 can include a processor that uses GPS data and sensor data collected from the vehicle to calculate performance metrics, which are then combined with GPS data and conveyed to the remote computing site.

### Hosted Website for Tracking Vehicle/Driver Performance Data

One aspect of the concepts disclosed herein is a hosted website, enabling drivers and fleet operators to monitor the performance of drivers and/or vehicles, based on data collected during the drivers' operation of a vehicle.

In general, one or more performance metrics are automatically collected while a driver is operating a vehicle, and that data is used to generate a score or rating of the driver's or vehicle's performance. In at least one embodiment, the score is normalized to enable driver/vehicle scores from other types of vehicles to be compared. Then, the driver/vehicle performance data is posted to the hosted website.

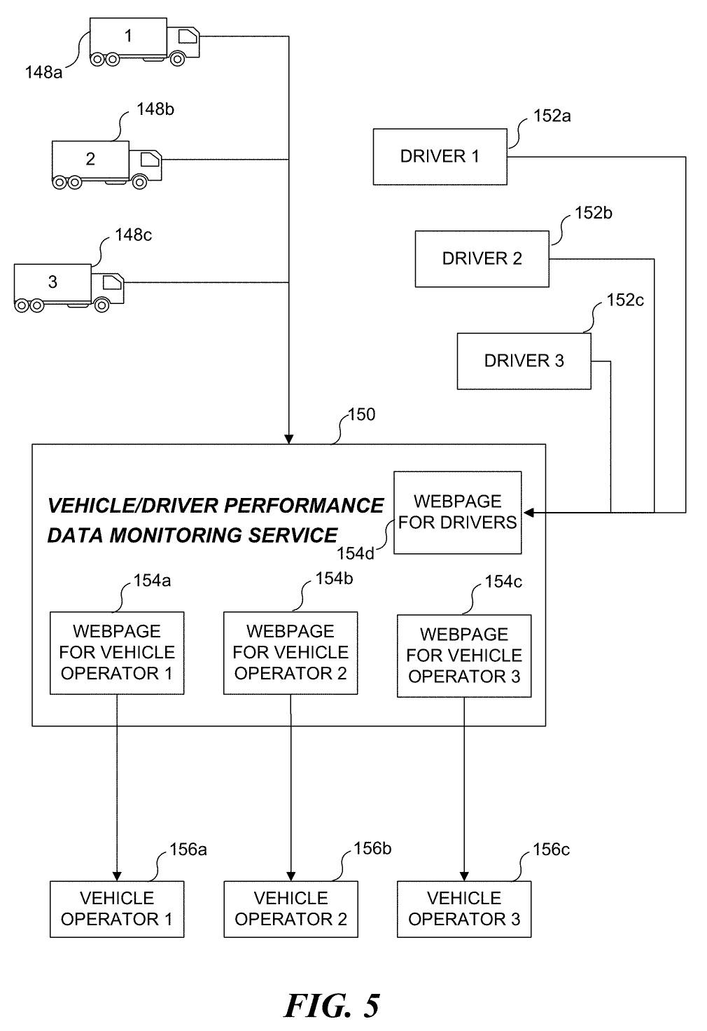

FIG. 5 is a functional block diagram of various elements that can be employed to implement the hosted driver/vehicle performance website concept, in one exemplary embodiment. The elements includes a plurality of enrolled vehicles 148a-148c (noting that the concepts disclosed herein can be applied to a different number of vehicles), a plurality of drivers 152a-152c (noting that the concepts disclosed herein can be applied to a different number of drivers), a plurality of vehicle operators 156a-156c (noting that the concepts disclosed herein can be applied to a different number of vehicle operators), and a remote monitoring service 150. Each vehicle includes the components discussed above in connection with FIG. 2 (noting the number and types of sensors disclosed in FIG. 2 are exemplary, and not limiting), enabling the vehicle to convey performance data from the vehicle to remote monitoring service 50, which monitors the performance data from each vehicle 148a-148c over time to enable the driver's performance while operating that vehicle to be evaluated. In an exemplary embodiment monitoring service 150 generates a webpage (as indicated by webpages 154a-154c) for each vehicle operator, so the vehicle operator can review the performance rankings of each of their drivers. It should be understood that the concepts disclosed herein also encompass other website designs, and the webpage per fleet is not the only possible model. In one embodiment, drivers will have their own webpage 154d (alternatively, drivers can access the webpage for their specific fleet).

It should be understood that monitoring service 150 is implemented using a remote computing device, and that the term remote computing device is intended to encompass networked computers, including servers and clients, in private networks or as part of the Internet. The monitoring of the vehicle/driver performance data and driver performance ranking by monitoring service 150 can be performed by multiple different computing devices, such that performance data is stored by one element in such a network, retrieved for review by another element in the network, and analyzed by yet another element in the network.

### Exemplary System Environment

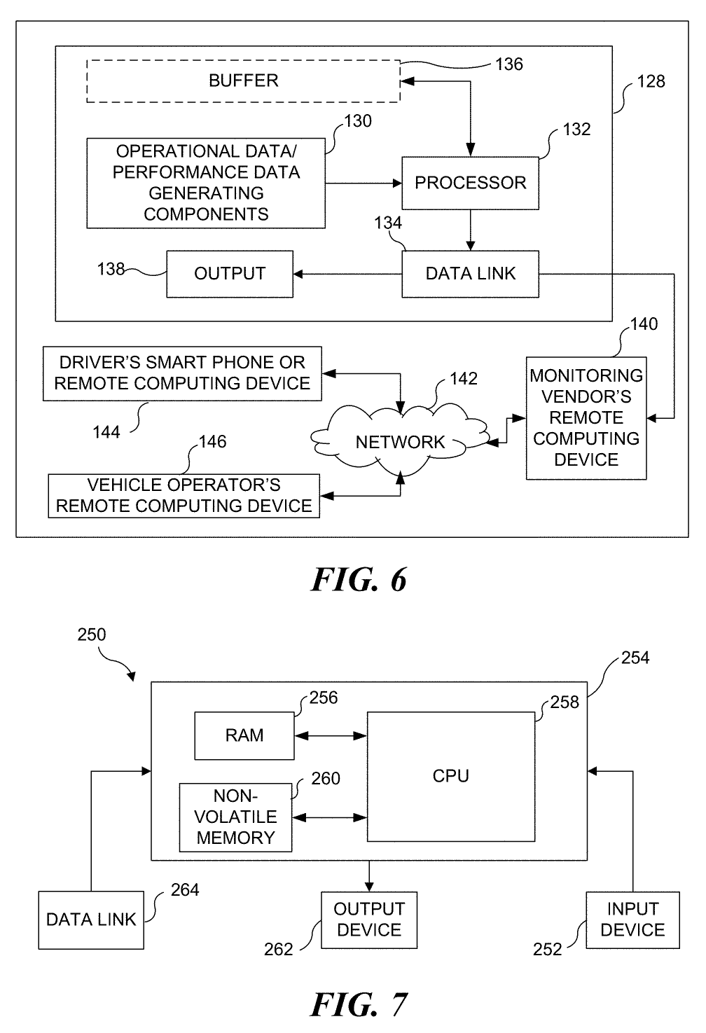

FIG. 6 is a functional block diagram of an exemplary system employed to implement some of the concepts disclosed herein. The functional block diagram illustrates exemplary components used in each vehicle 128 that is enrolled in a vehicle/driver performance monitoring service, to implement some of the method steps discussed above. An exemplary vehicle/driver performance monitoring service is based on adding an optional data buffer 136 (or other short-term memory storage) and a bi-directional data link 134 to each enrolled vehicle (in an exemplary, but not limiting embodiment, the data buffer and data link are combined into a single component). It should be understood that the short-term memory storage is not required for embodiments where the performance data transmitted from the enrolled vehicle does not include operational, vehicle, or driver related data that must be briefly stored. In an exemplary embodiment, the data link is a combination radio frequency (RF) transmitter and receiver, although separate transmitters and receivers could be used (note the term RF specifically encompasses cellular telephone-based data links). A data terminal can optionally be included in the vehicle to facilitate operator entry of information and operator transmission of information that is presented to the operator on a display within the vehicle. Data collected on a portable data collection device during an inspection can also be uploaded through such a data terminal, or independently by direct transmission to the remote monitoring service. While RF data transmission represents an exemplary embodiment, other types of data transmission could be employed. If the vehicle does not already include performance data/operational data collecting components 130, such components are added. Most vehicles manufactured today include operational data collecting components already, as many of today's vehicles are designed to use such continuously generated operational data to control operation of the vehicle in real-time, and such vehicles generally include data collecting components, data buses, and controllers that use the operational data to control the operation of the vehicle. The vehicle includes at least one processor 132 that performs the function of managing the transmission of performance data from the vehicle to the remote monitoring service, according to one or more of the transmission paradigms discussed herein. In embodiments where the performance data includes temporary storage of operational data, the processor also implements the function of temporarily storing operational data from components 130 in data buffer 136 or other temporary storage, and using bi-directional data link 134 to convey real-time performance data and/or the buffered operational/performance data from the enrolled vehicle to a remote computing device 140 (which is used to analyze the performance of the vehicle and/or driver). It should be understood, that those processor functions can be implemented by a single processor or distributed across multiple processors.

In some embodiments, an output 138 is also included, to provide information to the driver in a form that can be easily understood by the driver. Output 138 can be implemented using a speaker providing an audible output, and using a display providing a visual output. Note that output 138 can be combined into a single component with the data buffer and the data link, so only a single additional component is added to the vehicle (recognizing that most vehicles already include the additional required components, such as the operational data collecting components and the processor).

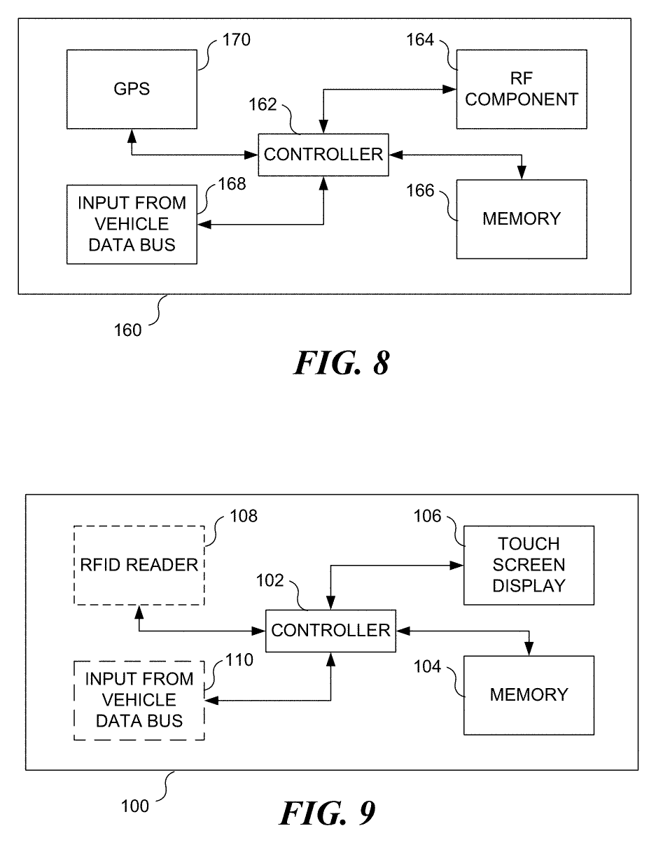

While not specifically shown in FIG. 6, in particularly preferred embodiments the vehicle is equipped with a GPS unit (exemplary GPS units are illustrated in FIGS. 4 and 8). In a related preferred embodiment, the processor, the GPS component, any buffer, and data link are combined into a single telematics device. Such a device will send GPS and vehicle/driver performance data to the remote computing device discussed below at a plurality of different times during the course of the operation of the vehicle. In general, the telematics device will transmit data at intervals ranging from as frequently as every 5 to 15 seconds, or as rarely as every 5 minutes, recognizing that such intervals can vary, and are intended to be exemplary, and not limiting.

As indicated in FIG. 6, remote computing device 140 (operated by the monitoring service) is logically coupled via a network 142 (such as the Internet) to a computing device 144 (such as a personal computer, a tablet, or a smart phone) accessible to a driver (in embodiments where driver performance rankings are shared with drivers, noting only one such driver device is shown in the Figure; however, the monitoring service will likely be monitoring the performance of a plurality of drivers, each likely having access to a different computing device 144), and a computing device 146 accessible to a vehicle operator (noting that in at least some embodiments, the monitoring service performs the monitoring function for a plurality of different vehicle operators/fleets). Network 142 facilitates communication between computing devices 140, 144, and 146, enabling the monitoring service to efficiently communicate with drivers and vehicle operators. It should be noted that the concepts disclosed herein encompass embodiments where the monitoring service and vehicle operator are the same entity.

The concepts disclosed herein are in at least some embodiments intended to be used by fleet owners operating multiple vehicles, and the performance data conveyed to the remote location for diagnosis will include an ID component that enables each enrolled vehicle to be uniquely identified.

### Exemplary Computing Environment

FIG. 7 is a functional block diagram of an exemplary computing device that can be employed to implement some of the method steps disclosed herein. It should be understood, that the concepts disclosed herein encompass processing of data collected at a vehicle both in the vehicle and at a remote computing device.

FIG. 7 schematically illustrates an exemplary computing system 250 suitable for use in implementing the processing functions disclosed herein. Exemplary computing system 250 includes a processing unit 254 that is functionally coupled to an input device 252 and to an output device 262, e.g., a display (which can be used to output a result to a user, although such a result can also be stored). Processing unit 254 comprises, for example, a central processing unit (CPU) 258 that executes machine instructions for carrying out an analysis of performance data (and in some embodiments, of position data) collected from enrolled vehicles, to present data regarding those vehicles to a one or more users. The machine instructions implement functions generally consistent with those described elsewhere herein (including generating and presenting custom GUIs to present fleet data). CPUs suitable for this purpose are available, for example, from Intel Corporation, AMD Corporation, Motorola Corporation, and other sources, as will be well known to those of ordinary skill in this art.

Also included in processing unit 254 are a random access memory (RAM) 256 and non-volatile memory 260, which can include read only memory (ROM) and may include some form of memory storage, such as a hard drive, optical disk (and drive), etc. These memory devices are bi-directionally coupled to CPU 258. Such storage devices are well known in the art. Machine instructions and data are temporarily loaded into RAM 256 from non-volatile memory 260. Also stored in the non-volatile memory are operating system software and ancillary software. While not separately shown, it will be understood that a generally conventional power supply will be included to provide electrical power at voltage and current levels appropriate to energize computing system 250.

Input device 252 can be any device or mechanism that facilitates user input into the operating environment, including, but not limited to, one or more of a mouse or other pointing device, a keyboard, a microphone, a modem, or other input device. In general, the input device will be used to initially configure computing system 250, to achieve the desired processing (i.e., to monitor vehicle performance data over time to detect a mechanical fault). Configuration of computing system 250 to achieve the desired processing includes the steps of loading appropriate processing software into non-volatile memory 260, and launching the processing application (e.g., loading the processing software into RAM 256 for execution by the CPU) so that the processing application is ready for use. In embodiments where computing system 250 is implemented in a vehicle, the computing system 250 can be configured to run autonomously, such that a user input device not regularly employed.

Output device 262 generally includes any device that produces output information but will most typically comprise a monitor or computer display designed for human visual perception of output. Use of a conventional computer keyboard for input device 252 and a computer display for output device 262 should be considered as exemplary, rather than as limiting on the scope of this system. In embodiments where computing system 250 is implemented in a vehicle, the computing system 250 can be vehicle performance data (and position data when desired) collected in connection with operation of enrolled vehicles to configured to run autonomously, such that a user output device not regularly employed.

Data link 264 is configured to enable data to be input into computing system 250 for processing. Those of ordinary skill in the art will readily recognize that many types of data links can be implemented, including, but not limited to, universal serial bus (USB) ports, parallel ports, serial ports, inputs configured to couple with portable memory storage devices, FireWire ports, infrared data ports, wireless data communication such as Wi-Fi and Bluetooth™, network connections via Ethernet ports, and other connections that employ the Internet.

Note that vehicle/driver performance data from the enrolled vehicles will be communicated wirelessly in at least some embodiments, either directly to the remote computing system that analyzes the data to evaluate the driver's performance, or to some storage location or other computing system that is linked to computing system 250.

It should be understood that the terms “remote computer”, “computing device”, and “remote computing device” are intended to encompass a single computer as well as networked computers, including servers and clients, in private networks or as part of the Internet. The vehicle/driver performance data received by the monitoring service from the vehicle can be stored by one element in such a network, retrieved for review by another element in the network, and analyzed by yet another element in the network. While implementation of the methods noted above have been discussed in terms of execution of machine instructions by a processor (i.e., the computing device implementing machine instructions to implement the specific functions noted above), the methods could also be implemented using a custom circuit (such as an application specific integrated circuit or ASIC). The concepts disclosed herein encompass collecting data from a vehicle during operation of the vehicle. The data collected is used to analyze the performance of at least one of the driver and the vehicle. In preferred embodiments, the data is collected during operation of the vehicle and wirelessly transmitted from the vehicle during its operation to a remote computing device using a cellular phone network-based data link. The frequency of such data transmissions can be varied significantly. In general, more data is better, but data transmission is not free, so there is a tension between cost and performance that is subject to variation based on an end user's needs and desires (some users will be willing to pay for more data, while other users will want to minimize data costs by limiting the quantity of data being transferred, even if that results in a somewhat lower quality data set). The artisan of skill will be able to readily determine a degree to which data quality can be reduced while still provide useful data set.

It should also be understood that the concepts presented herein encompass collecting data at a vehicle (location data as well as vehicle performance data, including data that can be used to analyze vehicle performance and driver behavior), wirelessly transferring such data to a remote server, enabling a remote computer user to access a computer network, processing user requests for data at one location (such processing including processing required to generate one or more of the GUIs disclosed herein, and presenting the data (and GUI) on a computer display at a second location.

Exemplary GPS Device with Onboard Computing Environment

FIG. 8 is a functional block diagram of an exemplary telematics device added to an enrolled vehicle to implement one or more of the methods of disclosed herein.

An exemplary telematics unit 160 includes a controller 162, a wireless data link component 164, a memory 166 in which data and machine instructions used by controller 162 are stored (again, it will be understood that a hardware rather than software-based controller can be implemented, if desired), a position sensing component 170 (such as a GPS receiver), and a data input component 168 configured to extract vehicle data from the vehicle's data bus and/or the vehicle's onboard controller (noting that the single input is exemplary, and not limiting, as additional inputs can be added, and such inputs can be bi-directional to support data output as well).

The capabilities of telematics unit 160 are particularly useful to fleet operators. Telematics unit 160 is configured to collect position data from the vehicle (to enable vehicle owners to track the current location of their vehicles, and where they have been) and to collect vehicle operational data (including but not limited to engine temperature, coolant temperature, engine speed, vehicle speed, brake use, idle time, and fault codes), and to use the RF component to wirelessly convey such data to vehicle owners. The exemplary data set discussed above in connection with calculated loaded cost per mile can also be employed. These data transmission can occur at regular intervals, in response to a request for data, or in real-time, or be initiated based on parameters related to the vehicle's speed and/or change in location. The term “real-time” as used herein is not intended to imply the data are transmitted instantaneously, since the data may instead be collected over a relatively short period of time (e.g., over a period of seconds or minutes), and transmitted to the remote computing device on an ongoing or intermittent basis, as opposed to storing the data at the vehicle for an extended period of time (hour or days), and transmitting an extended data set to the remote computing device after the data set has been collected. Data collected by telematics unit 160 can be conveyed to the vehicle owner using RF component 164. If desired, additional memory can be included to temporarily store data id the RF component cannot transfer data. In particularly preferred embodiments the RF components is GSM or cellular technology based.

In at least one embodiment, the controller is configured to implement the method of FIG. 1 by using one or more of data collected from GPS 170 and data from input 168.

### Exemplary Tablet for in Vehicle Use

FIG. 9 is a functional block diagram of an exemplary mobile computing device 100 for fleet telematics including a display 106 and a controller 102 configured to present at least one telematics application to a user. A non-transitory physical memory 104 is included, upon which machine instructions define one or more applications are stored. Device 100 includes an option RFID reader 108 (or other sensor) that enables an inspection application to verify that the device is proximate an inspection location (an optical scanner could also be employed, as well as other sensors). In exemplary but not limiting embodiments, the device includes at least one data input 110 that can be used to logically couple the device to a vehicle data bus.

Device 100 may include additional components, including but not limiting to a GSM component, a Wi-Fi component, a USB component, a rechargeable battery, and in at least one embodiment a GPS component.

### Newly Disclosed GUIs for Efficiently Presenting Fleet Metrics

FIG. 10 is an exemplary screen shot of a webpage (or GUI in a stand-alone software application, noting that when the term webpage is used herein, it should be understood that the same information can be generated in a stand-alone software product as long as the software has access to the data, and that the terms webpage and GUI are used herein interchangeably) accessed by a user to see summarized fleet information that can be used to quickly obtain a high level overview of the fleet, including location, alerts, uptime statistics, and in some cases maintenance statistics.

Referring to FIG. 10, a GUI 300 (or webpage 300) is presented to a user. GUI 300 provides summarized details to a user (such as a fleet manager), to enable the user to quickly view summarized and high-level details regarding the fleet. In at least some embodiments, GUI 300 would be the first, or one of the first, pages or screens a user would visit when using a fleet management software tool including GUI 300. A section 302 includes a map and a plurality of tabs 304. A header portion of section 302 informs the user that the fleet includes 5 vehicles, 1 of which has a critical defect. Each vehicle is presented on the map by a numbered icon 306. In at least some embodiments, hovering over or clicking on an icon will open a popup window providing details on that vehicle, which in some embodiments can include on or more of vehicle type, vehicle number, assigned driver, assigned route, max speed this trip, idle this trip, inspection status (completed or missed), hours on duty for driver (or hours remaining for hours of service regulations), last maintenance performed, next scheduled maintenance, MPG for trip, cost per loaded mile per trip, and driver performance ranking per trip. The relatively location of the vehicles on the map is updated on a regular basis. The updates are more or less in real-time (i.e., there may be a lag of seconds to minutes between updates, subject to the status of a data link between the fleet vehicles and a database used to generate the data displayed in GUI 300).

In at least some embodiments, the map portion of section 302 can be manipulated by the user, so that a relatively larger or relatively smaller geographical area is displayed. In at least one embodiment, the header portion (5 vehicles/1 critical defect) reflects the size of the entire fleet being monitored, not just the vehicles in the geographical area being displayed. In at least one embodiment, the header portion (5 vehicles/1 critical defect) reflects only information relating to the vehicles currently located in the geographical area being displayed.

The vehicle represented by icon 308 (vehicle 5) is presented using an icon having a different color, indicating that vehicle 5 is the vehicle that is exhibiting the critical defect noted in the header.

Tabs 304 map portion of section 302 can be manipulated by the user to change the emphasis of the data being displayed in the map portion of section 302. The current tab is the FLEET tab, so that the relative locations of fleet vehicles are displayed on the map. Selection of an ALERTS tab will result in only vehicles having active alerts (a speed alert, an idle alert, a driver monitoring alert, a zone or geofence alert, a missed inspection alert, a defect alert or an alarm alert) being displayed on the map. Selection of a DRIVERS tab will result in only vehicles having either selected drivers being displayed (one embodiment), or all vehicles will be displayed but selecting the vehicle icon will result in a popup window providing details on the driver (another embodiment). Selection of a ZONE tab will result in user defined geofences or zones being displayed on the map.

GUI 300 also includes a section 310, in which vehicle alert information is summarized. As noted in the header portion of section 302, one vehicle in this fleet has an active alert. Section 310 provides details of that alert. If a relatively large number of alerts exist, a scrollable list is presented in section 310. Section 310 efficiently informs the user that vehicle 5 on the map portion of section 302 is Fleet Vehicle #749, and the alert is that driver Bob George has had 4 speeding events during the current trip. Other possible alerts include one or more of an idle alert, a different driver monitoring alert (hard braking, excess fuel use, and/or excessive cornering speed), a zone or geofence alert, a missed inspection alert, a defect alert (from a driver inspection of vehicle diagnostic data, such as a fault code), or an alarm alert (low fuel, clogged filter, high temp in cargo area).

GUI 300 also includes a section 312, in which fleet uptime data is summarized for the user. Fleet vehicles are capital intensive, and efficient fleet management requires monitoring assets and drivers to maximum uptime. Section 312 includes a driver uptime metric and a vehicle uptime metric. For April of 2014, the vehicle uptime metric was only 50%, and the driver uptime metric was 75%. Users can filter this data by date and date range (timeframe tab) and by zone (ZONE tab). Note the icons are similar to pie charts or clock faces, with shading in the periphery of the circle corresponding to the relative percentage of uptime.

GUI 300 optionally includes a section 314, in which fleet maintenance information is summarized for the user. This hypothetical fleet uses two types of trucks; ACME brand trucks and LEMA brand trucks. Exemplary information for display in section 314 includes uptime statistic per brand (such as 74% ACME and 89% LEMA, enabling the user to quickly understand which brand of trucks provides better uptime for his fleet), major defects per brand (brake defects are more common in LEMA trucks, while fuel injectors are prone to fouling in ACME trucks, based on this fleet's maintenance records), operational cost per mile (such as $1.48 per mile for LEMA trucks and $1.51 per mile for ACME trucks), and/or upcoming scheduled maintenance (such as warranty repair for ACME unit #745, Preventive Maintenance for Fleet Vehicles #245, #256, and #455, and brake replacement for Fleet Vehicle #546).

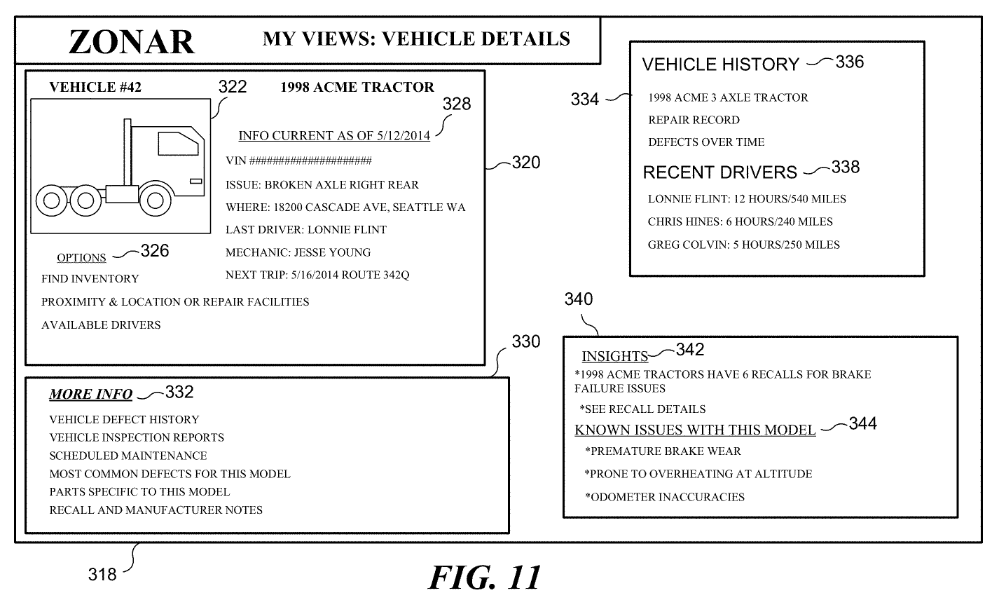

FIG. 11 is an exemplary screen shot of a webpage (or GUI in a stand-alone software application, noting that when the term webpage is used herein, it should be understood that the same information can be generated in a stand-alone software product as long as the software has access to the data, and that the terms webpage and GUI are used herein interchangeably) accessed by a user to see summarized information about a specific fleet vehicle, the vehicle information being presented to enable the user to quickly obtain a high level overview of that particular vehicle, including current status, current location, current driver, maintenance history, and insights by vehicle type.

Referring to FIG. 11, a GUI 318 (or webpage 300) is presented to a user. GUI 318 provides summarized details to a user (such as a fleet manager), to enable the user to quickly view summarized and high-level details regarding a specific vehicle. In at least some embodiments, GUI 318 is accessed from other pages/screens when using a fleet management software tool including GUI 318. In at least some embodiments, GUI 318 is accessed from GUI 300 of FIG. 10, for example by clicking on an asset in the map portion of section 302 to obtain more detailed information about particular vehicle.

GUI 318 includes a section 320, in which vehicle information is summarized. Such summary information can include an actual or stock photo 322 of the unit, the asset number (Vehicle #42), the type and model of the unit (1998 ACME Tractor), a portion 328 that provides static and current details regarding the vehicle (VIN, location, any current defects, last driver, mechanic, and current or next trip details), and a portion 326 that provides options for dealing with any issues identified in portion 328 (here, options include find inventory, proximity and location of repair shops, and drivers available to pick up the vehicle when it is returned to service). The information presented in section 320 can include one or more hyperlinks, enabling the user to navigate to a page or screen that will provide additional information. In some embodiments, instead of or in addition to hyperlinks, placing a cursor over information presented in section 320 will cause a popup window to be presented to the user, where additional details can be provided.

GUI 318 includes a section 330, in which additional vehicle information is available. Exemplary information available in section 330 includes one or more of vehicle defect history, vehicle inspection reports, maintenance schedules, most common defects for the make and model of this vehicle, parts specific to this make and model, and any recall or manufacturer notes about this make and model. Again, detailed information can be presented using hyperlinks and/or popup windows.

GUI 318 includes a section 334, in which historical information about this particular vehicle available, including information about the vehicle history in a portion 336 and information about the vehicle's drivers in a portion 338. Exemplary vehicle history information available in portion 336 includes one or more of in service date, name and type of vehicle, defects over time for this specific vehicle, fleet home location for this specific vehicle, purchase cost of this vehicle, maintenance costs to date for this vehicle, MPG for this vehicle, cost per loaded mile for this vehicle. In portion 338, names of the last 3 (noting that more or less names can be provided) drivers are provided. in some embodiments, along with the identity of the driver, information about the hours driven and mileage for that trip can be provided, as illustrated in FIG. 11. Even more detailed information can be presented using hyperlinks and/or popup windows.

GUI 318 includes a section 340, in which insights about make and model vehicle can be provided. Insights refers to information that is not collected from this specific vehicle during its operation (i.e., it is not position data, speed data, diagnostic data, vehicle performance data, or driver behavior data collected by a telematics device, such as that shown in FIG. 8). Rather, insights are based on 3^{rd} party information which may be useful to the fleet operating in understanding one or more known characteristics for the make and model of this vehicle. In a portion 342, the insights displayed in FIG. 11 include brake recall details for 1998 ACME tractors. In a portion 342, the insights displayed in FIG. 11 include known issues with this make and model vehicle, which include a tendency for premature brake wear, a tendency to overheat at high altitudes, and a tendency for odometer readings to be inaccurate. If a fleet manager is preparing a work order for a delivery that must occur by going over a mountain pass at a relatively high elevation, the fleet operator may determine that another vehicle is more suited to that route by reviewing the information on GUI 318 (and the insights in portion 344 of section 340 in particular.

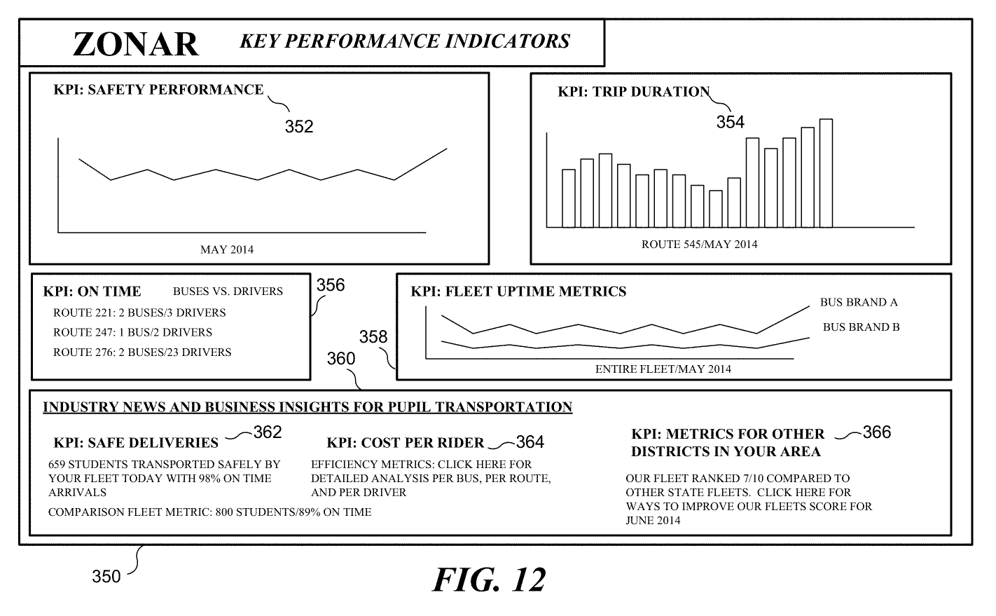

FIG. 12 is an exemplary screen shot of a webpage (or GUI in a stand-alone software application, noting that when the term webpage is used herein, it should be understood that the same information can be generated in a stand-alone software product as long as the software has access to the data, and that the terms webpage and GUI are used herein interchangeably) accessed by a user to see summarized information about a Key Performance Indicators (KPIs) for the fleet, the KPIs being presented to enable the user to quickly obtain a high level overview of the fleet performance, including metrics for the fleet operators own vehicles and when available metrics from similar fleets, so the fleet operator can identify areas that other fleets perform better in, to enable the fleet operator to understand where their own fleet performance can be improved.

Referring to FIG. 12, a GUI 350 (or webpage 350) is presented to a user. GUI 350 as shown includes KPIs for pupil transportation. It should be understood that KPIs can also be provided for different fleets, such as short haul local delivery fleets, sanitation fleets, and long haul over the road trucking fleets. GUI 350 provides summarized details to a user (such as a fleet manager), to enable the user to quickly view summarized and high-level details regarding fleet performance using key indicators. In at least some embodiments, GUI 350 is accessed from other pages/screens when using a fleet management software tool including GUI 350. In at least some embodiments, GUI 350 is accessed from GUI 300 of FIG. 10, for example by clicking on the FLEET UPTIME header in section 312.

GUI 350 thus graphically illustrates a plurality of design elements related to pupil transportation, including a plurality of safety related insights, including insights specific to the fleet, and to the industry as a whole. Thus, one aspect of the concepts disclosed herein is a fleet performance monitoring GUI for pupil transportation that simultaneously safety metrics specific to that operators own fleet, and for the industry as a whole on the same screen.

GUI 350 includes a section 352, in which the user is presented information about their fleet's safety performance (i.e., a safety performance KPI). In an exemplary embodiment, safety statistics for a user selectable date range (May of 2014 in FIG. 12) are graphically displayed. Exemplary safety statistics include on or more of: speeding events, defects noted by inspections, missed inspections, child left on bus events, missed stops, and late arrivals. In some embodiments, more detailed information can be presented using hyperlinks and/or popup windows.

GUI 350 includes a section 354, in which the user is presented information about their fleet's trip duration performance (i.e., how long individual trips took). For fleets providing pupil transportation, preferably trips (at least along the same route) will have generally consistent durations. In an exemplary embodiment, trip duration statistics for a user selectable date and route range (Route 545/May of 2014 in FIG. 12) are graphically displayed. In this example, a relatively large variation in trip duration is occurring, and the fleet operator may want to investigate. In at least one embodiment, the fleet analysis software package that GUI 350 is part of will monitor the duration of each route, and send an email or text alert to the fleet manager whenever the variation exceeds some user defined parameter (i.e., plus or minus 5%, 10%, 15%, or 20%, such variations being exemplary, and not limiting). In some embodiments, more detailed information can be presented using hyperlinks and/or popup windows.

GUI 350 includes a section 356, in which the user is presented information about their fleet's on time performance, based per driver or per route (i.e., how often buses were late when being operated by a particular driver or along a particular route). For fleets providing pupil transportation, on time performance is an expectation of parents and educators. If the number of routes cannot be accommodated in the size allocated, a scrollable list is presented. In some embodiments, routes/drivers with the worst on time performance are listed first. In some embodiments, the fleet data is filtered and only routes/drivers exceeding a user defined threshold (i.e., more than 1 late event per week, or per day) are presented in section 356 (this is an example of management by exception based reporting, results falling within defined parameters do not need to be reviewed). As shown in FIG. 12, on time performance for 3 routes, including multiple buses and drivers are presented. In some embodiments, more detailed information can be presented about particular routes, buses, and/or drivers using hyperlinks and/or popup windows.

GUI 350 includes a section 358, in which the user is presented information about their fleet's up time metrics. This can be based on per driver, per route, per bus, or fleet wide, based on user selectable parameters. As shown in FIG. 12, section 358 graphically presents fleet wide uptime metrics to the user. Note that the data is being presented based on two different types of buses being operated by this fleet. This summarized up time data efficiently informs the user that in the month of May 2014 the Brand A buses had significantly higher up time statistics than Brand B. The fleet operator may use this data to negotiate a discounted price for Brand B buses, or to document then need to purchase Brand A buses in the future as new buses are needed. In some embodiments, more detailed information can be presented using hyperlinks and/or popup windows.

Finally, GUI 350 includes a section 360, in which the user is presented with insights about their fleet's performance, which when possible enables comparisons with other similar fleets. As noted above, such insights often include data collected from 3^{rd} party sources (i.e., not just data collected from the fleet's own vehicles). In a portion 362, one insight is based on comparing the fleets own safe delivery metrics with metrics from some other pupil transportation fleet. Clearly, this requires the fleet analysis software to be able to acquire data from some other pupil transportation fleet. Vendors of fleet analysis software may offer customers some sort of incentive to enable anonymized metrics to be shared with other users. Trade associations may make such metrics available for their members use. The safe delivery KPI in portion 362 indicates the fleet operator achieved delivery of 659 students on today's date (or some user selectable date or date range) with 98% on time arrivals. The comparison fleet achieved 800 students delivered with an 89% on time metric. Both fleets delivered similar quantities of students, and the fleet operator's fleet compared well with on time deliveries. This data reassures the fleet operator that their performance is meeting industry norms. In a portion 364 cost per rider statistics are available for the fleet operator and a comparison fleet (if such data is available). More detailed information can be presented using hyperlinks and/or popup windows. In a portion 366, summarized data for the fleet operator is compared to summarized data from as many other fleets as possible, to provide a ranking relative to the other fleets. Portion 366 provides a gateway (via hyperlink or popup window) to suggestions for improving the fleet's performance in the upcoming time period.

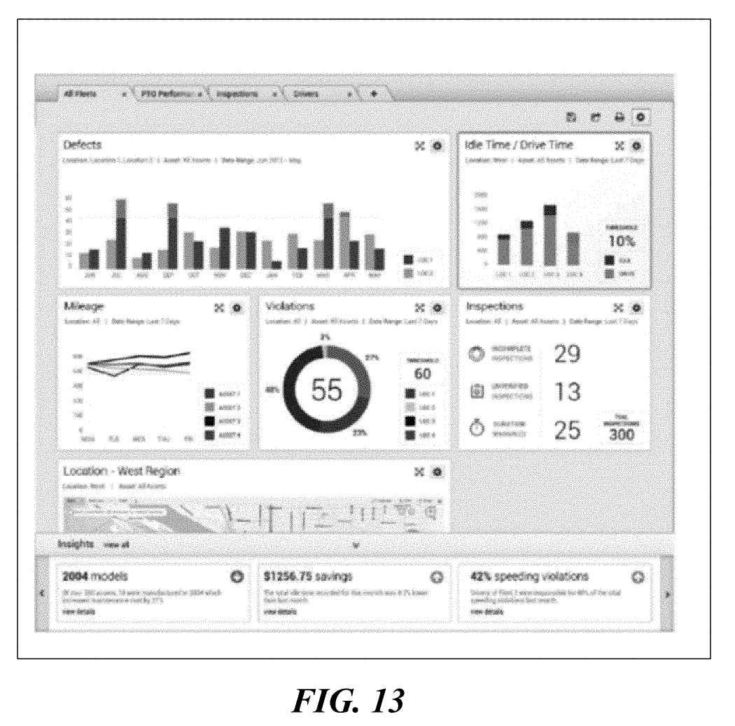

FIG. 13 is an exemplary screen shot of a webpage (or GUI) accessed by a user to see summarized fleet information that can be used to quickly obtain a high level overview of key performance indicators for the fleet, including vehicle defects, idle time metrics, mileage metrics, speed violation metrics, and vehicle inspection metrics. FIG. 13 thus shows a GUI 400 (or webpage 400) presented to a user. GUI 400 as shown includes KPIs for over the road trucking and private fleets. It should be understood that KPIs can also be provided for different fleets, such as short haul local delivery fleets, sanitation fleets, and pupil transportation. GUI 400 provides summarized details to a user (such as a fleet manager), to enable the user to quickly view summarized and high-level details regarding fleet performance using key indicators. In at least some embodiments, GUI 400 is accessed from other pages/screens when using a fleet management software tool including GUI 400. In at least some embodiments, GUI 400 is accessed from other web pages, such as GUI 300 of FIG. 10, for example by clicking on the FLEET UPTIME header in section 312.

GUI 400 thus graphically illustrates a plurality of design elements related to pupil transportation, including a plurality of safety related insights, including insights specific to the fleet, and to the industry as a whole.

GUI 400 includes a section 402, in which the user is presented information about their fleet's number of reported defects over time. In an exemplary embodiment, defect statistics are present each month for the past 12 months, though it should be understood that the concepts disclosed herein encompass a user selectable date range. In the embodiment of FIG. 13, the defects are presented as a bar graphs, allowing defects for vehicles at 2 different locations to be compared (note many fleet operate multiple locations, and the GUI of FIG. 13 allows data for different locations to be easily compared. In some embodiments, more detailed information can be presented using hyperlinks and/or popup windows.

GUI 400 includes a section 404, in which the user is presented information about their fleet's idle time metrics, again comparing metrics for multiple locations. Users can be allowed to select date ranges and different locations to compare (this applies to each portion of FIG. 13). A user selectable threshold value can be displayed (in the embodiment of FIG. 13, the threshold has been set at 10% of vehicle use). In the embodiment of FIG. 13, both drive time and idle time (summarized across all vehicles at that location, which is true for each portion of FIG. 13 comparing data for vehicles across locations, though it should be understood an option can be provided to allow data for individual vehicles to be compared) are shown in a bar graph using different shading. Thus, the user can quickly determine how much idle time verses drive time is achieved at each fleet location.

GUI 400 includes a section 406, in which the user is presented information about their fleet's total completed mileage metrics, this time comparing metrics for different vehicles (across 1 location or multiple locations). Users can be allowed to select date ranges, different locations, and/or different individual vehicles to compare (note this applies to each portion of FIG. 13). In the embodiment of FIG. 13, the user is comparing metrics for four different user selected vehicles, though summarized data for different locations rather than individual vehicles can be compared (summarized across all vehicles at each selected location.

GUI 400 includes a section 408, in which the user is presented information about their fleet's speed violation metrics, again comparing metrics for multiple locations. Users can be allowed to select date ranges and different locations to compare (this applies to each portion of FIG. 13). A user selectable threshold value can be displayed (in the embodiment of FIG. 13, the threshold has been set at 60 MPH). In the embodiment of FIG. 13, each location is presented as a portion of a ring graph, with a percentage displayed next to the sub portion of the ring. For example, section 408 indicates that 48% of the vehicles for location 3 kept their speed at 55 MPH or lower at all times.

GUI 400 includes a section 410, in which the user is presented information about their fleet's vehicle inspection metrics. Users can be allowed to select date ranges and different locations to compare (this applies to each portion of FIG. 13). Note in section 410, the metrics for all vehicles in all locations have been summarized, to present an aggregate total rather than comparing summarized data for different locations. Section 410 displays total inspections (300), the number of incomplete inspections (29), the number of unverified inspections (13, this requires a verified inspection systems such as Zonar's EVIR system), and the number of inspection duration warnings (25, these are based on time data that suggests an inspection was performed in very little time, and may have been a poor quality inspection). Note that the concepts disclosed herein allow different inspections-based metrics to be used and displayed in section 410.

GUI 400 includes a section 412, in which the user is presented selectable options for defining a specific location and one or more assets (vehicles) for insights to be presented in a section 414. The insights displayed in section 414 include a summary of maintenance costs (the selected location has 18 vehicle form 2004 who are responsible for 27% of repair costs), a metric of the savings due to reduced idle time for the current month ($1256.75 saved), and a summary of the speeding violation of drivers in the selected location (42% of the total fleets speeding violations occurred in the selected location). Note that the concepts disclosed herein allow different insight to be used and displayed in section 414.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

1. A data display system, comprising:
(a) a data link configured to receive data regarding a plurality of fleet vehicles;
(b) a central processing unit (CPU) operatively coupled to the data link;
(c) a non-transitory memory device operatively coupled to the CPU;
(d) a display device, which is operatively coupled to the CPU;
(e) wherein the non-transitory memory device contains a computer program instructions, which when executed on the CPU, causes the CPU to:
(i) generate an image of, a first data element that presents vehicle defect metrics for the plurality of fleet vehicles;
(ii) generate an image of a second data element that presents user idle time metrics for the plurality of fleet vehicles;
(iii) generate an image of a third data element that presents speed violations metrics for the plurality of fleet vehicles.

2. The data display system of claim 1, wherein the computer program instructions additionally cause a fourth data element to be generated on the display device, the fourth data element presenting total miles traveled for a defined period of time for substantially all of the plurality of fleet vehicles.

3. The data display system of claim 1, further wherein the computer program causes a fourth data element to be shown on the display, the fourth data element presenting vehicle inspection metrics for the fleet of vehicles.

4. The data display system of claim 1, further wherein the CPU receives data for each vehicle in the fleet of vehicles over the data link, and wherein the computer program causes the CPU to combine the data from the vehicles, to arrive at fleet metrics.

5. A data-receiving display system, comprising:
(a) a data link for receiving data regarding a fleet of vehicles;
(b) a central processing unit (CPU);
(c) a non-transitory computer readable memory;
(d) a display; and
(e) wherein the non-transitory computer readable memory contains a computer program that when executed on the CPU, causes the following data elements to be shown on the display:
(i) a first data element that presents vehicle inspection metrics for the fleet of vehicles;
(ii) a second data element that presents user idle time metrics for the fleet of vehicles;
(iii) a third data element that presents speed violations metrics for the fleet of vehicles.

6. The data-receiving display system of claim 5, further wherein the computer program causes a fourth data element to be shown on the display, the fourth data element presenting total miles traveled for a defined period of time for the fleet of vehicles.

7. The data-receiving display system of claim 5, further wherein the computer program causes a fourth data element to be shown on the display, the fourth data element presenting vehicle defect metrics for the fleet of vehicles.

8. The data-receiving display system of claim 5, further wherein the system receives data for each vehicle in the fleet of vehicles over the data link, and wherein the computer program causes the CPU to combine the data from the vehicles, to arrive at fleet metrics.

9. A data-receiving display system, comprising:
(a) a data link for receiving data regarding a fleet of vehicles;
(b) a central processing unit (CPU);
(c) a non-transitory computer readable memory;
(d) a display; and
(e) wherein the non-transitory computer readable memory contains a computer program that when executed on the CPU, causes the following data elements to be shown on the display:
(i) a first data element that presents vehicle completed inspection metrics for the fleet of vehicles;
(ii) a second data element that presents vehicle defect metrics for the for the fleet of vehicles;
(iii) a third data element that presents speed violations metrics for the fleet of vehicles.

10. The data-receiving display system of claim 9, further wherein the computer program causes a fourth data element to be shown on the display, the fourth data element presenting total miles traveled for a defined period of time for the fleet of vehicles.

11. The data-receiving display system of claim 9, further wherein the computer program causes a fourth data element to be shown on the display, the fourth data element presenting idle time metrics for the fleet of vehicles.

12. The data-receiving display system of claim 9, further wherein the system receives data for each vehicle in the fleet of vehicles over the data link, and wherein the computer program causes the CPU to combine the data from the vehicles, to arrive at fleet metrics.
